(19) United States
(12) Patent Application Publication
(10) Pub. No.: US 2014/0305556 A1
(43) Pub. Date: Oct. 16, 2014

(54) WIPER GUARD

(71) Applicant: Florence Moore, Tucson, AZ (US)

(72) Inventor: Florence Moore, Tucson, AZ (US)

(21) Appl. No.: 14/253,746

(22) Filed: Apr. 15, 2014

Related U.S. Application Data
(60) Provisional application No. 61/812,152, filed on Apr. 15, 2013.

(51) Int. Cl. B60S 1/04

(52) U.S. Cl. CPC B60S 1/0491
USPC 150/154

(57) ABSTRACT

The wiper guard is a form-fitting sheath produced in a lightweight but tough and durable, heat-, cold-, and UV-resistant vinyl. The closed end of the sheath constitutes a scabbard which slides over one end of the wiper-blade. The second half of the wiper guard folds over the second half of the wiper blade longitudinally and is equipped with mating strips of VELCRO® along the top and bottom edges to fasten the wiper guard in place. A central VELCRO® tab connects the two halves of the wiper guard together.

### CLAIM OF PRIORITY

This patent application claims priority under 35 USC 119 (e) (1) from U.S. Provisional Patent Application Ser. No. 61/812,152 filed Apr. 15, 2013, of common inventorship herewith entitled, “Wiper Guard.”

### BACKGROUND OF THE INVENTION

1. Field of the Invention

This invention relates generally to a wiper guard and, more particularly, the invention relates to a wiper guard providing a paired set of removable vinyl sheaths or covers for a vehicle's windshield-wiper blades for protecting the wiper blades when the wipers are not in use, thus extending their working life and effectiveness.

2. Description of the Prior Art

Like tires, brakes, headlights and turn signals, windshield wipers are essential safety equipment of the automobile; and like these, windshield wiper blades must be maintained in good condition, and replaced when worn. Unlike tires and brakes, windshield wiper blades are worn not only by use, but by exposure -exposure to the damaging ultraviolet rays of sunlight, exposure to heat and to sub-freezing temperatures, to airborne dust and grit, ice and sleet and snow. In fact it is these elements, more than the wear and tear of normal use that takes their toll on windshield wiper blades and necessitates their replacement. The rubber blades can become cracked and brittle; they can separate into shreds; in hot weather they can become stuck to the glass, and in cold weather they can become frozen to the glass. Worn and damaged wiper-blades lose their effectiveness, and thus impair the driver's vision.

### BRIEF DESCRIPTION OF THE DRAWINGS

FIGS. 1-3 are perspective views illustrating a wiper guard, constructed in accordance with the present invention.

### DETAILED DESCRIPTION OF THE PREFERRED EMBODIMENTS

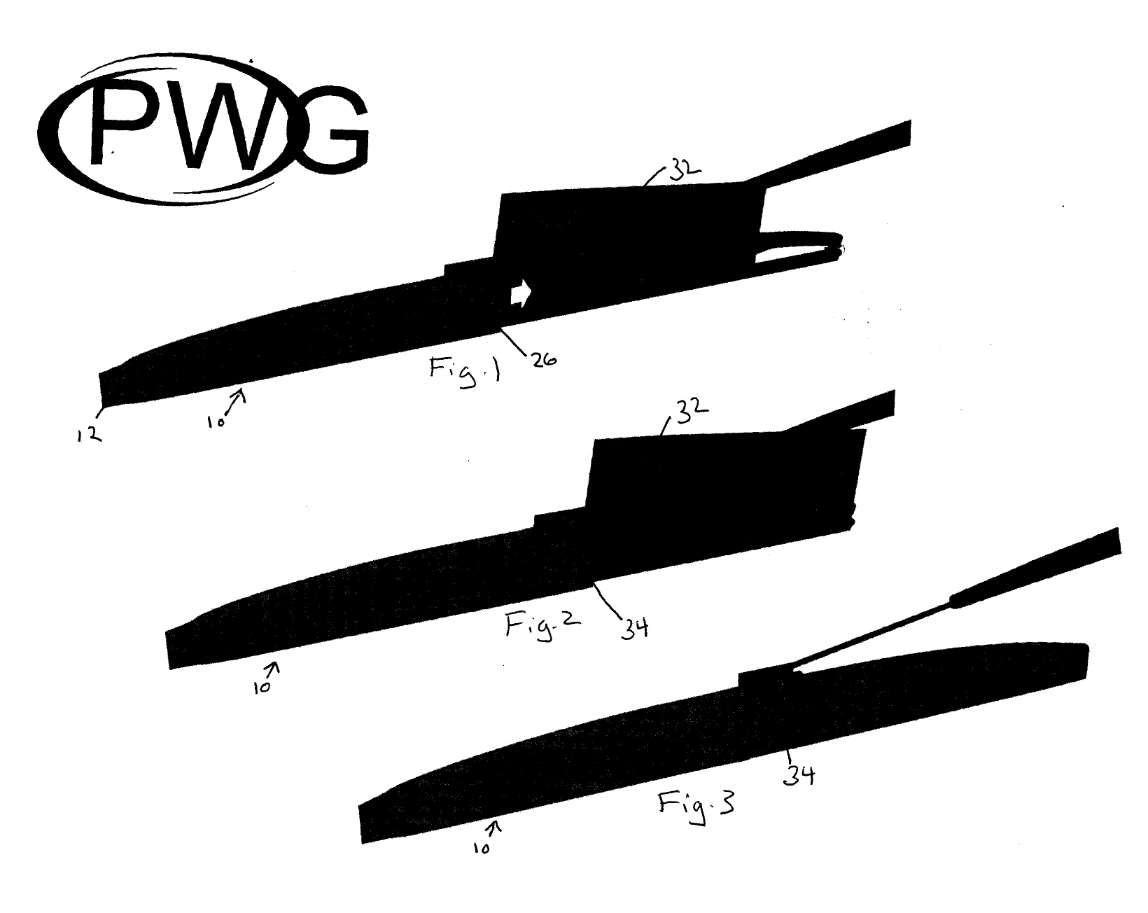

FIG. 1 shows a windshield wiper with one section of the device of present invention in place over one half of the windshield wiper showing the direction of movement of the wiper guard onto the wiper.

FIG. 2 shows a windshield wiper with one section of the device of present invention in place over one half of the windshield wiper, and the second half of the wiper guard above the remaining half of the wiper awaiting folding over the wiper and to be held in place by means of VELCRO® closure along the length of the second half of the wiper guard.

FIG. 3 shows a windshield wiper completely covered and protected by both sides of the wiper guard of the present invention.

As illustrated in FIGS. 1-3, the present invention is a wiper guard providing a paired set of removable vinyl sheaths or covers for a vehicle's windshield-wiper blades for protecting the wiper blades when the wipers are not in use, thus extending their working life and effectiveness.

The wiper guard of the present invention is a form-fitting sheath 10, produced in a lightweight but tough and durable, heat-, cold-, and UV-resistant vinyl, and several lengths to closely correspond with the most popular sizes of wiper-blades for passenger cars, vans, pickups, and SUVs. The closed end of the sheath is double-stitched 12 and constitutes a pocket or scabbard which will slide over one end of the wiper-blade. A rectangular VELCRO® tab 26 is situated at the center-point of the wiper guard and the tab and mates with a VELCRO® receiver on the second half of the wiper guard; and the second half of the wiper guard folds over the second half of the wiper blade longitudinally and is equipped with mating strips of VELCRO® along the top 32 and bottom edge of the second half of the wiper guard, such that the second half of the wiper guard folds over the second half of the wiper blade, with the VELCRO® strips providing a secure, dependable closure, and effectively sealing the wiper-blade into the guard. At the center-point of the guard, atop the VELCRO® center-tab, will be an oval logo 34 with the stylized initials of the system within the oval. FIG. 3 shows the wiper completely encased by the wiper guard of the present invention. The wiper guard can be available in several different styles, including one (or more) that covers not only the wiper-blade, but the entire wiper-arm as well. The guard can be produced not only in varying lengths and depths, but also in a variety of colors and finishes, as this accessory has been designed with both function and style in mind.

The wiper guards of the present invention take only a moment to install or remove, yet provide an essential benefit to all motorists. This vinyl and VELCRO® sheath or cover, produced and sold in pairs, will simply slide over the wiper-blade(s), then be sealed with a VELCRO®, press-together closure. The wiper guards will then protect the wiper-blades from exposure to the elements, i.e., from the rays of the sun that can rot rubber and “glue” the blades to the windshield glass; from extremes of cold and ice that can freeze the blades in a sheath of ice. The wiper guards, too, will protect not only the wiper-blades, but the windshield glass as well, which can be scratched and marred by old, stiff, grit-laden blades. Easy to use and sporty to look at, the wiper guards save motorists the expense of replacing windshield-wiper blades so often, by extending the working life and effectiveness of the blades; and these easily affordable, well-designed automotive accessories should find a wide and enthusiastic reception from the motoring public.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A wiper guard system comprising a paired set of removable sheaths or covers for a vehicle's windshield-wiper blades for protecting the wiper blades when the wipers are not in use wherein the wiper guard is a form-fitting sheath, wherein the closed end of the sheath is double-stitched and constitutes a pocket or scabbard which will slide over one end of a wiper-blade, further comprising a rectangular VELCRO® tab situated at the center-point of the wiper guard and the tab mates with a VELCRO® receiver on the second half of the wiper guard; and the second half of the wiper guard folds over the second half of the wiper blade longitudinally and is equipped with mating strips of VELCRO® along the top edge and bottom edge of the second half of the wiper guard, such that the second half of the wiper guard folds over the second half of the wiper blade and is secured by the VELCRO® strips.

2. The wiper guard system of claim 1, further comprising an oval logo mounted on the top of the VELCRO@ tab situated at the center-point of the wiper guard.

3. The wiper guard system of claim 1, wherein the wiper guard is manufactured in several different styles, including one (or more) that covers not only the wiper-blade, but the entire wiper-arm.

4. The wiper guard system of claim 1, wherein the wiper guard is produced in varying lengths and depths.

5. The wiper guard system of claim 1, wherein the wiper guard is produced in a variety of colors and finishes.

6. The wiper guard system of claim 1, wherein the wiper guard is made from durable, heat-, cold-, and UV-resistant vinyl.

7. The wiper guard system of claim 1, wherein the wiper guard is made in several lengths to closely correspond with the most popular sizes of wiper-blades for passenger cars, vans, pickups, and SUVs.
